(19) United States
(12) Patent Application Publication
(10) Pub. No.: US 2018/0217788 A1
(43) Pub. Date: Aug. 2, 2018

(54) INFORMATION PROCESSING APPARATUS, STORAGE MEDIUM, AND METHOD

(71) Applicant: CANON KABUSHIKI KAISHA, Tokyo (JP)

(72) Inventor: Masashi Nakagawa, Sagamihara-shi (JP)

(21) Appl. No.: 15/882,395

(22) Filed: Jan. 29, 2018

(30) Foreign Application Priority Data
Jan. 31, 2017 (JP) 2017-016118

(51) Int. Cl. G06F 3/12; G06F 9/445; G06F 9/4401

(52) U.S. Cl. CPC G06F 3/1204; G06F 9/44505; G06F 3/1248; G06F 9/4413; G06F 3/1231

(57) ABSTRACT

An information processing apparatus operable to execute an operating system comprises a processor which is capable of executing the instructions causing the information processing apparatus to, at a time different to the obtainment processing by the operating system and after the installation of the device driver, execute, by using a second time interval which is a time interval longer than a first time interval, a plurality of requests for obtaining the configuration information from a peripheral apparatus using a function for obtaining the configuration information, and wherein obtained information is saved as the configuration information of the peripheral apparatus.

### BACKGROUND OF THE INVENTION

### Field of the Invention

The present invention relates to a technique for obtaining configuration information of a peripheral apparatus.

### Description of the Related Art

Conventionally, a peripheral apparatus such as a printer, a scanner, a camera, and a 3D printer is used with a computer after installing a device driver on the computer. For example, when printing a file such as a document or figure generated on a computer from an application, it is typical to use a printer driver installed on the computer to convert rendering data to a page description language, and transmit this to a printer which is a peripheral apparatus. In such a case, setting of print settings such as a type of a sheet, whether to print both sides, whether to print in color, and a sheet feed method is performed by using a user interface for print setting held by an application, or by using a user interface (hereinafter, also referred to as UI) for print setting presented by the printer driver.

In addition, as a connection configuration between a peripheral apparatus and a computer, there is Web Services for Devices (referred to as WSD) which was introduced with Windows Vista (registered trademark). In WSD there is a mechanism for, when a device driver corresponding to a peripheral apparatus is installed on a computer, performing a bidirectional communication with the peripheral apparatus, obtaining configuration information comprising capability information, option configuration information, or the like of the peripheral apparatus, and notifying the device driver of the configuration information. The option configuration information indicates information relating to an option configuration, such as a device that can be additionally set or an additional function, with respect to the peripheral apparatus. Specifically, in a printer example, there is information relating to a function or an option unit such as a finisher option apparatus for enabling stapling or hole punching with respect to printed sheets, or an option feed cassette apparatus for increasing print sheets. In addition, there is a mechanism for, by a standard TCP/IP port, obtaining similar option configuration information by SNMP (Simple Network Management Protocol) and notifying the option configuration information to a device driver. This mechanism is referred to as AutoConfig. Recitation regarding AutoConfig is given in Japanese Patent Laid-Open No. 2005-25755. The printer driver can save the option configuration information obtained by such a mechanism, and perform settings or display a GUI in accordance with the option configuration.

With the previously described AutoConfig mechanism provided by an OS, there are cases where the option configuration information of a peripheral apparatus cannot be obtained correctly. In particular, in a case where an OS of a predetermined version or higher is executed on a computer and a peripheral apparatus and the computer are connected by a standard TCP/IP port, a data loss of configuration information such as the option configuration information may occur due to a network environment. This is, because each option configuration information obtainment request from the OS is a request by UDP (User Datagram Protocol) which is very fast and there is no resend of a request even if a response from the peripheral apparatus is delayed, the information is treated as unobtained. When a data loss of the configuration information obtained via a function of an OS occurs, a device driver often operates as though the option configuration was not present. For example, in a case where option configuration for a feed tray or a feed cassette is subject to data loss, the printer driver treats sheet feed methods thereof as unusable, and these sheet feed methods cease to be settable even in a print setting UI. As a result, there is the problem in that, even though an option feed cassette is installed in the printer, feeding from this feed cassette cannot be performed at a time of printing. In this way, there is a problem in that, in accordance with data loss of configuration information based on an OS function, a function corresponding to the configuration information that was lost cannot be used by the device driver.

### SUMMARY OF THE INVENTION

The present invention provides an information processing apparatus capable of reducing problems due to data loss of configuration information described above such as at the time of installation of a device driver, a method, and a storage medium.

According to an aspect of the present invention, there is provided an information processing apparatus operable to execute an operating system, wherein the operating system is configured to, at a time of an installation of a device driver, perform obtainment processing for executing, by using a first time interval, a plurality of requests for obtaining configuration information from a peripheral apparatus corresponding to the device driver, the information processing apparatus comprising: a memory storing instructions; and a processor which is capable of executing the instructions causing the information processing apparatus to: at a time different to the obtainment processing by the operating system and after the installation of the device driver, execute, by using a second time interval which is a time interval longer than the first time interval, a plurality of requests for obtaining the configuration information from the peripheral apparatus by using a module having a function for obtaining the configuration information, and wherein information obtained by using the module, which is not the operating system, is saved as the configuration information of the peripheral apparatus.

By virtue of the present invention, it is possible to reduce problems due to the data loss of the configuration information that is caused by an OS function for obtaining the configuration information that is described above.

Further features of the present invention will become apparent from the following description of exemplary embodiments with reference to the attached drawings.

### BRIEF DESCRIPTION OF THE DRAWINGS

FIG. 1 is a system configuration diagram which illustrates an example of a configuration of a print system to which print apparatuses, servers and client computers of a print processing system according to embodiments of the present invention can be applied.

FIG. 2 is a block configuration diagram of a system in which a generic computer is used for the print processing system according to embodiments of the present invention.

FIG. 3 is a block configuration diagram of a print system of the print processing system according to embodiments of the present invention.

FIG. 4 is a block configuration diagram of an installer module of the print processing system according to embodiments of the present invention.

FIG. 5 is a sequence diagram in which option configuration information is obtained from a printer at a time of installing a printer driver of the print processing system according to embodiments of the present invention.

FIG. 6 is a flowchart which describes PreConfig processing of the print processing system according to embodiments of the present invention.

FIG. 7 is a view which illustrates an example of a definition of option configuration information obtained by AutoConfig of the print processing system according to embodiments of the present invention.

FIG. 8 is a flowchart for describing processing for determining whether or not to perform PreConfig at the time of an installation of the print processing system according to embodiments of the present invention.

FIG. 9 is a flowchart for describing processing for determining whether or not to perform PreConfig at the time of an activation of a print setting screen in the print processing system according to embodiments of the present invention.

FIG. 10 is an example of a message screen displayed when a print setting screen of the print processing system according to embodiments of the present invention is activated.

FIG. 11 is a flowchart for describing processing for determining whether to enable/disable a setting item at a time of activation of a print setting screen in the print processing system according to embodiments of the present invention.

FIG. 12 is a view for illustrating an example of the print setting screen of the print processing system according to embodiments of the present invention.

FIG. 13 is a view for illustrating a second example of the print setting screen of the print processing system according to embodiments of the present invention.

### DESCRIPTION OF THE EMBODIMENTS

### First Embodiment

<Configuration of Print Processing System and Constituent Elements Thereof>

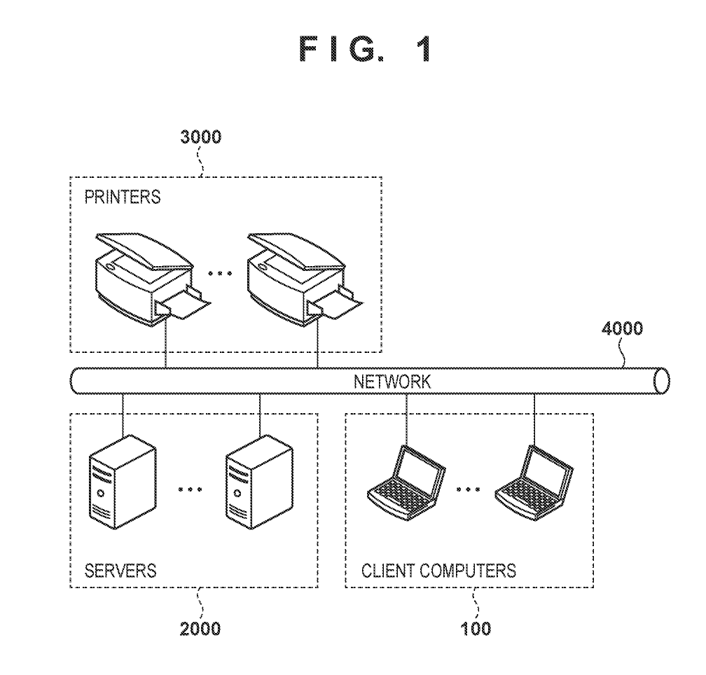

FIG. 1 is a system configuration diagram which illustrates an example of a configuration of a print system to which print apparatuses, servers and client computers of a print processing system according to embodiments of the present invention can be applied. The print system of the present embodiment is configured by one or more client computers 100 (for example, one for each user), one or more servers 2000 (for example, set on each floor), and one or more printers 3000 (for example, set on each floor). Furthermore, configuration is such that the foregoing client computers 100, servers 2000, and printers 3000 are connected via a network 4000. The network 4000 may be a small-scale to a large-scale network, such as a PAN (Personal Area Network) or a LAN (Local Area Network), and these devices are all connected to the network. Note that, in the present embodiment, a printer or a print apparatus indicates a device that includes a printer, and for example a multi-function peripheral device (MFP) is included as a printer or a print apparatus.

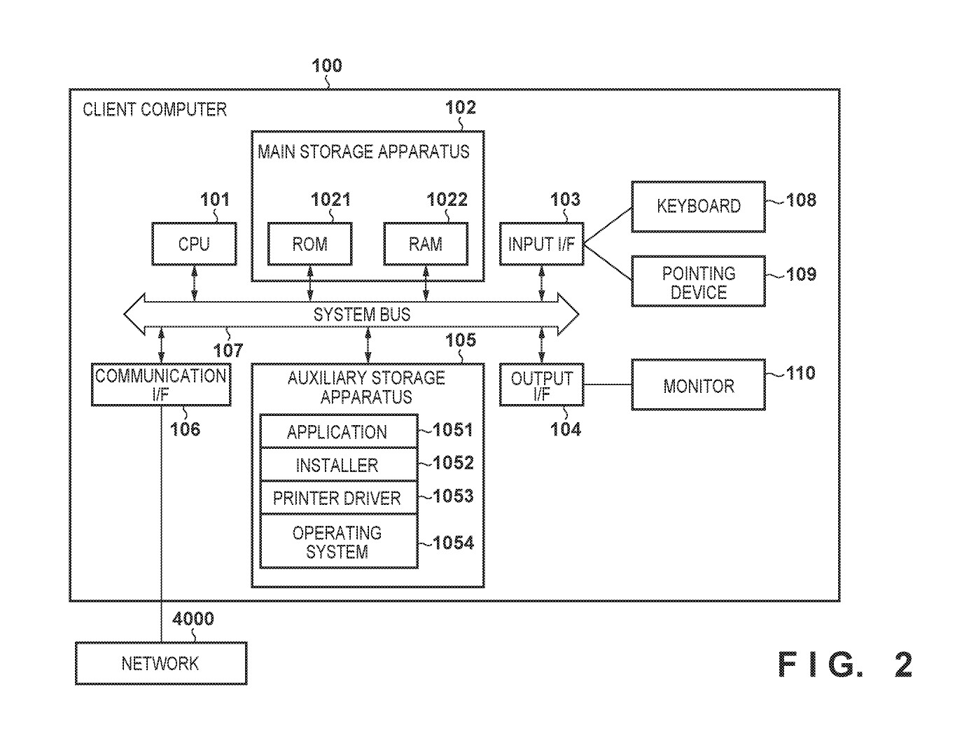

FIG. 2 is a block configuration diagram of a system in which a generic computer, in other words an information processing apparatus, is used for the print processing system according to embodiments of the present invention. Here, description is given for a configuration of a client computer 100, but unless specifically stated a server 2000 has a similar configuration. A CPU 101 controls the entirety of a PC 100 in accordance with a program stored in an auxiliary storage apparatus 105, or a RAM 1022 or a ROM 1021 of a main storage apparatus 102. The RAM 1022 is used as a work area for when the CPU 101 performs various processing. The auxiliary storage apparatus 105 stores various programs such as an application 1051, an installer 1052, a printer driver 1053, and an operating system 1054. Note that, hereinafter, the application 1051 may be represented as an application, the printer driver 1053 may be represented as a driver, and the operating system 1054 may be represented as an OS. An input device such as a keyboard 108 or a pointing device (mouse) 109 typified by a mouse, a touch panel, or the like is connected to the PC 100 through an input I/F 103. An output device such as a monitor 110 is connected to an output I/F 104, and a user interface (UI) is displayed on the monitor in accordance with an instruction from a program. An operation from a user with respect to a program is received through these input/output devices. A communication I/F 106 is connected to the network 4000, and can communicate with a device external to the PC 100, for example the servers 2000 or the printers 3000 of FIG. 1. Elements described above are connected by a common data system bus 107, and data can be exchanged between elements. The programs 1051-1054 can be added to the auxiliary storage apparatus 105 via a CD-ROM or a USB memory (not shown). They can also be added to the auxiliary storage apparatus 105 via the network 4000. Note that it goes without saying that, unless specifically stated, if function of the present invention is executed, the present invention can be applied irrespective of the configuration of a device. Application may be made to a stand-alone device, a system comprising a plurality of devices, or a system in which processing is performed after establishing a connection via a network such as a LAN or a WAN.

<Software Configuration of Print System>

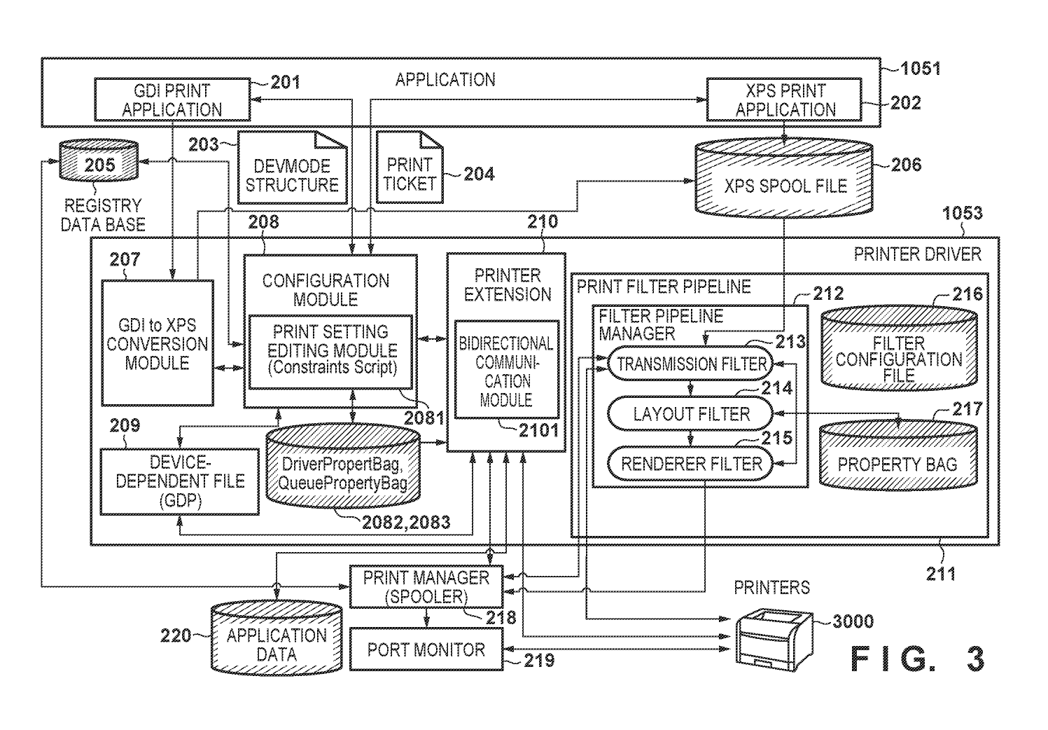

FIG. 3 is a block configuration diagram of a print system of the print processing system according to embodiments of the present invention.

A print system is a system that performs printing by using an XPS file format as spool data. The print system operates on the operating system 1054. A print manager 218, a GDI to XPS conversion module 207, a filter pipeline manager 212, and a port monitor 219 are modules that are included in the operating system 1054. GDI is a graphics component for generating a print image for a printer, and XPS is an XML-based format for describing an electronic document. XPS is employed by Microsoft Corporation's Windows (registered trademark) in place of GDI, and the GDI to XPS conversion module 207 is prepared to maintain compatibility of data from GDI to XPS. In the present embodiment, XPS is a native format, and GDI data is printed after being converted to XPS data. The GDI to XPS conversion module 207 has a function for converting data rendered in GDI to XPS data. The filter pipeline manager 212 is a module for managing filter print processing which is a feature of an XPS print pass. The port monitor 219 can control communication between a printer driver and the print manager 218 which accesses a printer, and the printer driver 1053 performs print processing via the port monitor 219. In addition, the print manager 218 communicates with a printer 3000 through the port monitor 219 to perform AutoConfig. In the present embodiment, a related application that has an assist function such as for providing a GUI for a device driver that corresponds to a peripheral apparatus also has an obtainment function for obtaining configuration information from the peripheral apparatus. Specifically, a printer extension 210 which is one example of this related application is assumed to have a route for directly communicating with the printer 3000 to obtain option configuration information indicating a configuration of an option unit for the printer 3000 without going via the print manager 218 or the port monitor 219. In FIG. 3, the GDI to XPS conversion module 207, the configuration module 208, and the filter pipeline manager 212 are included in the printer driver 1053, but they are placed as modules of the printer driver 1053 that are provided from the operating system 1054. The configuration module 208 can edit print setting information by using a print setting editing module 2081 provided by the printer driver 1053. The print setting editing module 2081 is written in a scripting language called Constraint Script, and edits print setting information by using property bags 2082 and 2083 provided by a printer driver. A property bag indicates a region in which a data group referred to as a DriverPropertyBag 2082 that is used as model-dependent information for a printer, and a data group referred to as a QueuePropertyBag 2083 that is linked to a print queue are held.

The DriverPropertyBag 2082 is printer-model-dependent data present in a driver package, and the data group is held as read-only in a specific region in the OS after installation of the printer driver.

The QueuePropertyBag 2083 can be used by registering a key-value pair xml definition file in the OS, and a value can be edited under a particular authority. In addition, GPD which is a print setting definition file can also record a definition of the QueuePropertyBag 2083.

Each filter of the filter pipeline manager 212 and the printer driver 1053 are stored as the printer driver 1053 in the auxiliary storage apparatus 105 of FIG. 1. A GDI print application 201 and an XPS print application 202 are stored as the application 1051 in the auxiliary storage apparatus 105 of FIG. 1. The GDI print application 201 and the XPS print application 202 are applications for generating print data by the GDI and XPS formats, respectively, and are document processing applications or the like, for example. A user uses an input apparatus such as the keyboard 108 or the pointing device 109 which is typified by a touch panel or a mouse to execute print processing from the XPS print application 202 (hereinafter, abbreviated as XPS application) or the GDI print application 201 (hereinafter, abbreviated as GDI application) which is shown on the monitor 110 of the output apparatus. The print processing is executed by performing three processes in order: selection of a printer, generation of a print setting, and conversion of rendering data. Note that the XPS print application and the GDI print application are referred to collectively as a print application.

Firstly, a printer 3000 to which printing is desired is selected from a screen of the print application. From a user's perspective, selection of a printer 3000 means the same thing as selecting a printer driver 1053 that corresponds to the printer 3000 that will execute printing. Selection of the printer driver 1053 uses a print queue (not shown).

Next a print setting is generated. For the print setting, firstly the application 1051 allocates a memory region for the print setting in the RAM 1022. The application 1051 calls the configuration module 208 of the selected printer driver 1053, and generates and stores print setting data. A binary DEVMODE structure 203 is used as print setting data by the GDI application 201, and a PrintTicket 204 recorded in XML which is a markup language is used by the XPS application 202. The DEVMODE structure 203 has a standard region that the operating system 1054 defines, and an extension region that the printer driver 1053 independently defines. The PrintTicket 204 is print setting information that is described in an XML format, and the recording of the standard region is separated from that of extension region by a namespace. Because print setting data also includes model-specific information, the configuration module 208 uses a device-dependent file 209 to generate the print setting data. The DEVMODE structure 203 or the PrintTicket 204 hold the print setting, and an application changes the print setting by directly rewriting values. The device-dependent file 209 indicates a print setting definition file referred to as GPD, and it is recorded as a text-based file. The print setting definition file, which is the device-dependent file 209, can record definitions of QueuePropertyBag which is linked to a print queue, an option configuration of the printer, and capabilities of the printer.

Dedicated print settings that are dependent on the printer 3000, which includes prohibition information, are set by a user interface that the printer extension 210 has. In accordance with setting of the user interface, the printer driver 1053 changes settings that depend on the printer 3000 of the PrintTicket 204 or the DEVMODE structure 203. For the PrintTicket 204, because the print setting is described in an XML format, it is easy for the XPS application 202 to rewrite all setting values by directly changing them, but the user interface of the printer extension 210 may be used to change settings. The printer extension 210 is a type of the printer driver 1053, and installation as an application separate to the printer driver 1053 is performed.

The print setting is generated each time there is printing of a document or the like, but settings that are desired to be held such as an environment setting for each user or an option unit configuration for a printer 3000 is saved in a registry database 205 of the operating system 1054 by the printer extension 210. When the registry database 205 cannot be used, the printer extension 210 saves the settings in application data 220. A default value for a print setting is saved in the registry database 205 by the print manager 218 of the operating system. The registry database 205 and the application data 220 are saved in the auxiliary storage apparatus 105.

When the print setting is finalized, a user executes print processing from an application. In a case of printing from the GDI application 201, rendering data is sent to the GDI to XPS conversion module 207 which is an OS module and converted to an XPS format, and an XPS spool file 206 is generated. At this point, the GDI to XPS conversion module 207 calls the configuration module 208, and converts the print setting from the DEVMODE structure 203 to the PrintTicket 204. When converting, the print setting editing module 2081 is used by the configuration module 208.

In contrast, when printing from the XPS application 202, there are two methods: generating an XPS file by the XPS application itself, or the operating system 1054 generating an XPS file in accordance with a rendering command from the XPS application. Regardless of the method, the XPS spool file 206 is generated in the process of printing.

When the XPS spool file 206 is generated in accordance with a print instruction being made from the GDI application 201 or the XPS application 202, processing is passed to a print filter pipeline 211. The print filter pipeline 211 is a mechanism by which printing is performed after a plurality of filters are applied, and controls an order and a number of filters by a filter configuration file 216. In the present embodiment, it is configured by a transmission filter 213 having a mechanism for communicating with the printer 3000, a layout filter 214 having a mechanism for performing a layout process for binding or stamping, and a renderer filter 215 having a mechanism for rendering the XPS spool file 206 to convert the XPS spool file 206 to PDL (Page Description Language). PDL data is managed by the print manager 218 which performs schedule management for print processing, and print jobs are registered in a queue one after another. When the printer 3000 has entered a state where it is capable of printing, jobs are transmitted, via the port monitor 219, to the printer 3000 in the order that they were registered in the queue. With such a configuration, print processing is performed with the main role of a printer driver being converting print data from an application to PDL data.

<Configuration of Installer Module>

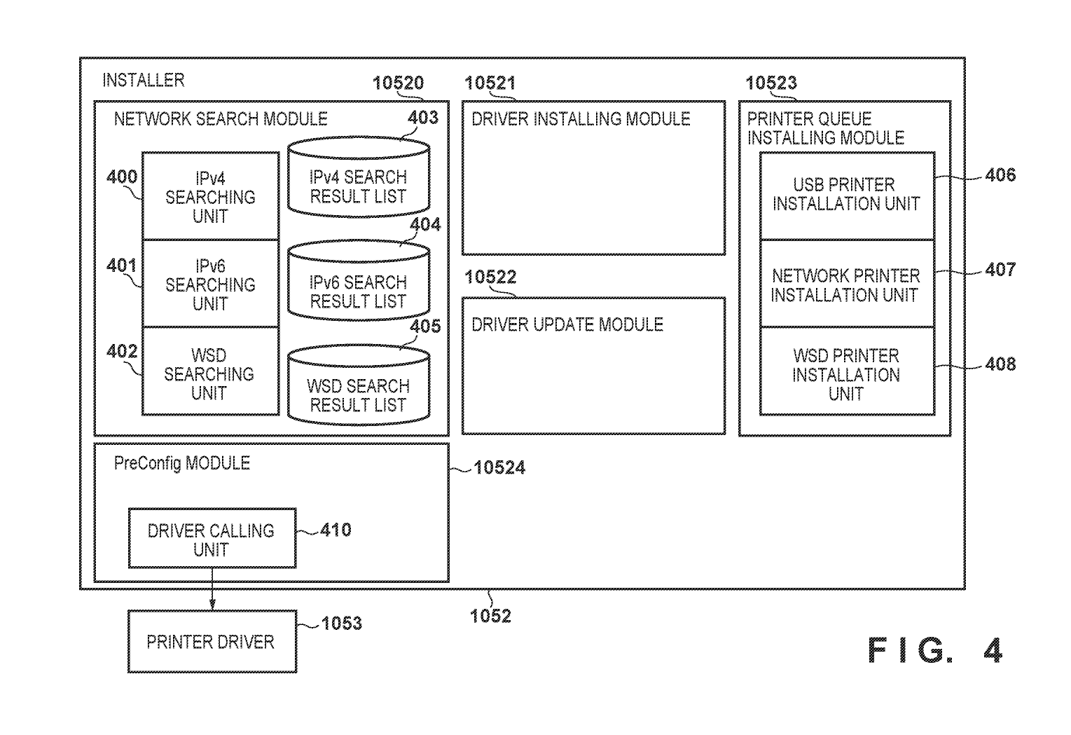

FIG. 4 is an example of a block configuration diagram of an installer 1052 of the print processing system according to embodiments of the present invention. A basic configuration of the block diagram is as follows.
A network search module 10520
A driver installing module 10521
A driver update module 10522
A printer queue installing module 10523
A PreConfig module 10524

These software modules are stored in the auxiliary storage apparatus 105, and, in accordance with a user request or a request by another system, loaded from the auxiliary storage apparatus 105 into the RAM 1022 and executed by the CPU 101. The network search module 10520 is configured by an IPv4 searching unit 400, an IPv6 searching unit 401, and a WSD searching unit 402. The network search module 10520 is a module that incorporates a function for searching for printers connected by the network 4000. Protocols to search by are IPv4, IPv6, and WSD, and, in accordance with a user instruction, each of the IPv4 searching unit 400, the IPv6 searching unit 401, and the WSD searching unit 402 communicate with the printers 3000 by a respective protocol, and list all printers that could be communicated with. Lists of results that were found are respectively saved in an IPv4 search result list 403 by the IPv4 searching unit 400, saved in an IPv6 search result list 404 by the IPv6 searching unit 401, and saved in a WSD search result list 405 by the WSD searching unit 402. A device to be searched for is a typical device, but in the present example, printers in particular are to be searched for.

The driver installing module 10521 is a module for installing a device driver, and can install the device driver in accordance with an installation instruction, for example. The driver update module 10522 updates an installed driver in accordance with, for example, information indicating that the driver has been revised. In the present embodiment, a corresponding driver is installed with respect to a device, in particular a printer, that is found on the network, but the install process is performed by the printer queue installing module 10523.

The printer queue installing module 10523 is configured by a USB printer installation unit 406, a network printer installation unit 407, and a WSD printer installation unit 408. The USB printer installation unit 406 installs a target printer driver 1053 in advance, and subsequently performs a USB plug and play installation. A plug and play install is a mechanism where, when a client computer 100 is connected to a printer 3000, the OS 1054 automatically performs installation and setting of the printer driver 1053. This is one technique for improving usability because, in accordance with the procedure, a user can use the printer by simply connecting the printer 3000 and the client computer 100 by a cable. There is a plug and play install for cases of a WSD port, and in these cases there is no need to connect a cable, and by selecting a desired printer 3000 from a list of printers found in accordance with the procedure, the printer becomes usable. The PreConfig module 10524 has a driver calling unit 410, and, after printer queue installation completes, instructs the printer driver 1053 which was installed as needed to perform option configuration information obtainment.

<Procedure for Obtaining Option Configuration Information>

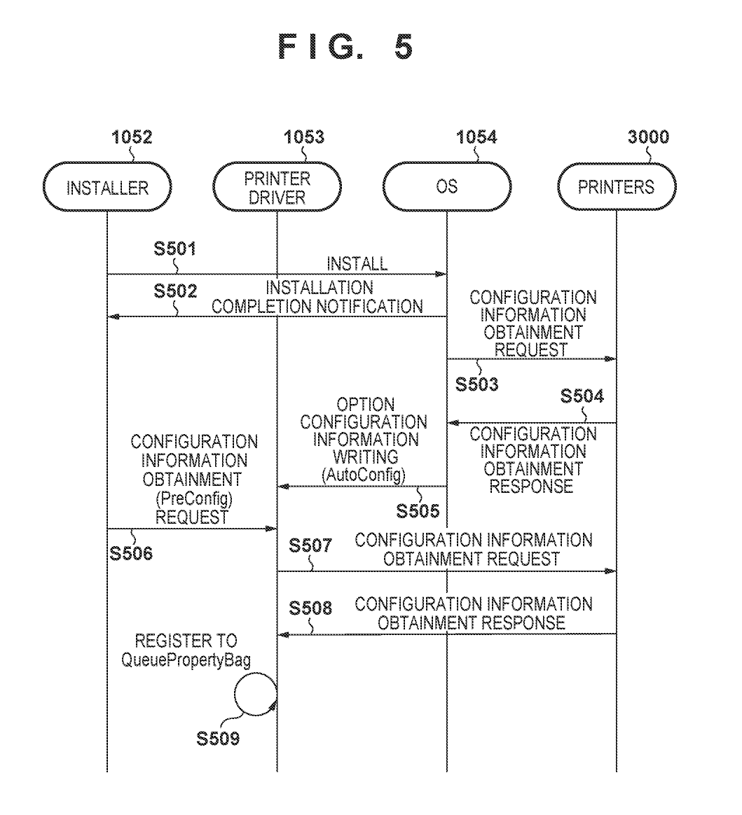

FIG. 5 is a sequence diagram in which option configuration information is obtained from a printer at a time of installing a printer driver of the print processing system according to embodiments of the present invention. Firstly the installer 1052 makes an installation instruction to the OS 1054 (step S501). The installation instruction is output by the USB printer installation unit 406, the network printer installation unit 407, or the WSD printer installation unit 408 in accordance with a result of searching for a printer, for example. The OS 1054 receives the installation instruction from the installer 1052, performs an install process for the printer driver 1053, and, when that process completes, performs installation completion notification processing with respect to the installer 1052 (step S502). When installing the printer driver 1053, if a corresponding printer extension 210 is not yet installed, the printer extension 210 will also be installed in conjunction with the driver installation. At the same timing, an obtainment request for option configuration information is performed with respect to the printer 3000 (step S503). Upon receiving from the OS 1054 the obtainment request for option configuration information, the printer 3000 examines the current option configuration information, and delivers a result of this examination to the OS 1054 as response information (step S504). When the obtainment processing for the option configuration information from the printer 3000 completes, the OS 1054 writes the option configuration information to the QueuePropertyBag 2083 of the installed printer driver 1053 (step S505). The series of processing thus far is referred to as AutoConfig.

Meanwhile, upon receiving the installation completion notification from the OS 1054, the installer 1052 performs a configuration information obtainment request (or instruction) with respect to the corresponding printer driver 1053 (step S506). In the present embodiment, because the printer extension 210 has a function for obtaining configuration information, it is also possible to make an obtainment request (or instruction) for configuration information directly to the printer extension 210. Upon receiving the configuration information obtainment request from the installer 1052, the printer driver 1053 collaborates with the printer extension 210 to make an obtainment request for the option configuration information to the printer 3000 (step S507). Upon receiving from the printer driver 1053 the obtainment request for option configuration information, the printer 3000 examines the current option configuration information, and delivers a result of this examination to the printer driver 1053 as response information (step S508). When the obtainment processing for the option configuration information completes, the printer driver 1053 registers this information in the QueuePropertyBag 2083 (step S509). In a case where the installer 1052 makes an obtainment request for configuration information to the printer extension 210, the printer extension 210 registers information obtained from the printer in the QueuePropertyBag 2083.

The series of processing from step S506 to here is referred to as PreConfig in contrast to the AutoConfig (automatic configuration) that the OS 1054 performs in step S503 through step S504. Because AutoConfig is processing for obtaining the option configuration information which is controlled by the print manager 218 included in the OS 1054, the option information that is obtained is defined by a vendor, but a method of obtaining it depends on the OS 1054. While it is possible to obtain all of the option configuration information by one communication with the printer when the connection port is a WSD port, because the obtainment is performed by SNMP in the case of a standard TCP/IP port, the obtainment of the option configuration information from the printer can be performed in a plurality to several tens of communications, in accordance with the number of options. Because this plurality of communications is performed from the OS 1054 with an interval of approximately 0.1 milliseconds (this is referred to as a first time interval) in accordance with the environment, there may be cases where processing does not keep up on the printer 3000 side, and a response is not made in time. Moreover, SNMP is UDP-based and response acknowledgment is not performed. As a result, a data loss of the option configuration information occurs.

In contrast, for the PreConfig, because communication with the printer 3000 is all controlled by the driver 1053 without going through the print manager 218, it is possible to reduce a number of communications with the printer 3000, and have the communication interval be a time interval (a second time interval) longer than the first time interval, for example. Furthermore, it is possible to determine whether obtainment of the configuration information succeeded for each option configuration at an application level, and attempt the same option configuration information obtainment again in the case of a failure. As a result, data loss of the option configuration information is less than for AutoConfig. Alternatively, it is possible to stop data loss as long as there is no physical impediment or the like for communication.

In this manner, in accordance with the procedure of FIG. 5, it is possible to obtain the option configuration information by PreConfig even if the OS fails to obtain the option configuration information by AutoConfig. Note that, in the sequence of FIG. 5, configuration is such that PreConfig is performed after AutoConfig. Accordingly, configuration may be taken such that, for example, after the installer 1052 has received an installation completion notification, a determination on whether the obtainment processing of AutoConfig overall has completed in accordance with completion of the writing of configuration information by AutoConfig is made by polling the OS 1054 or the printer driver 1053. Alternatively, upon receiving a PreConfig request, the printer driver 1053 may delay this processing until completion of the writing of the option configuration information by AutoConfig (step S505), and perform an obtainment request with respect a printer for the configuration information (step S507) after step S505 completes. Alternatively, the printer driver 1053 may be configured to ignore writing of option configuration information by AutoConfig that is undertaken after reception of a PreConfig request in accordance with an installation completion notification.

<PreConfig Processing>

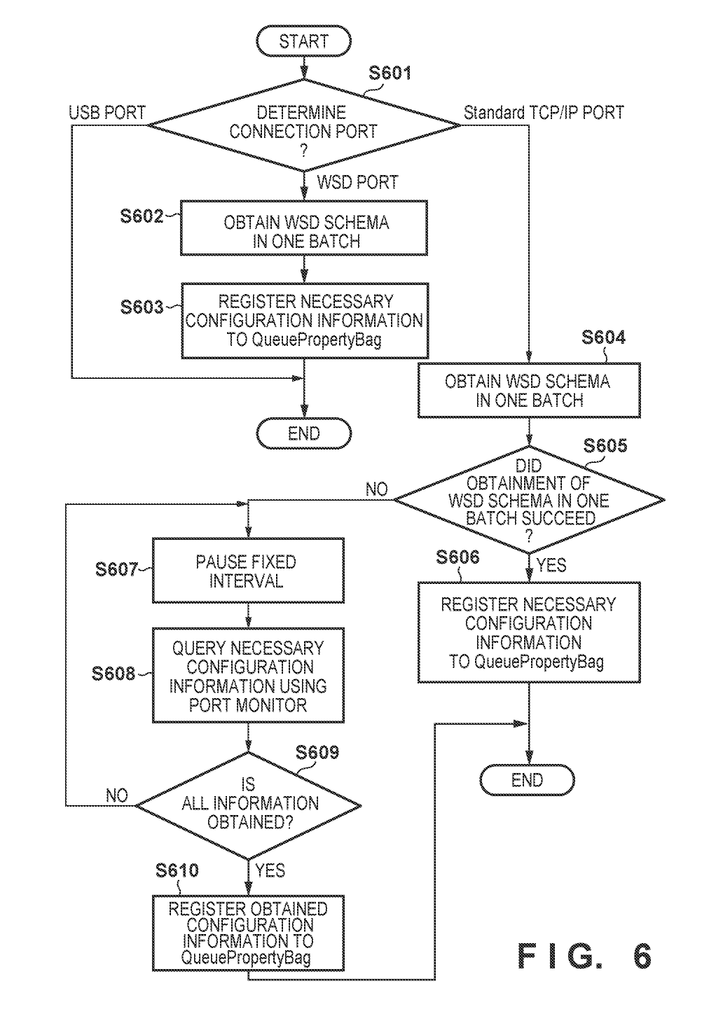

FIG. 6 is a flowchart which describes PreConfig processing of the print processing system according to embodiments of the present invention. Unless particularly specified, processing of each step of the flowchart is performed by the printer extension 210. The printer extension 210 is stored in the auxiliary storage apparatus 105, loaded into the RAM 1022, and executed by the CPU 101.

As described by FIG. 5, this processing occurs when the installer 1052, having received a completion notification for the install process (step S502) from the OS 1054, requests the printer driver 1053 for obtainment of configuration information, and is realized by the printer extension 210 which is a module that is related to the printer driver 1053. In other words this processing is executed in response to the request in accordance with step S506.

Firstly, the type of the connection port connected to the printer 3000 is discriminated (step S601). A reason for discriminating the connection port is that since the AutoConfig processing performed by the OS 1054 differs for each connection port, there are differences between information that can be obtained by the respective processing, and therefore there is a need to change the PreConfig processing. When the connection port is a WSD port (a case where it is determined to be a WSD port in step S601), a WSD schema that includes option configuration information is obtained in one batch (step S602). Necessary option configuration information is extracted from the obtained WSD schema, and registered in the QueuePropertyBag 2083 (step S603). Configuration may be taken such that storage processing in accordance with the registration of the configuration information to the QueuePropertyBag 2083 is executed by the printer driver 1053, having received the obtainment result instead of the printer extension 210.

Note that WSD is an abbreviation of Web Services for Devices (or Web Services on Devices). Obtainment of the WSD schema does not fail due to a setting on a printer side being a setting where the WSD schema cannot be used, because the WSD schema can be used when the connection port is the WSD port. However, because failure due to the communication environment is possible, re-obtaining of the option configuration information is attempted in PreConfig. Accordingly, although this is omitted in FIG. 6, configuration may be such that, immediately after step S602, it is determined whether obtainment of the WSD schema in one batch succeeded, and a retry is made when this did not succeed.

In a case of a standard TCP/IP port in the port discrimination determination (step S601) (a case where a standard TCP/IP port is determined in step S601), firstly obtainment of the WSD schema in one batch is performed (step S604). This processing is the same as step S602. When there is a WSD port connection, obtainment of the WSD schema in one batch does not fail due to a setting on a printer side being a setting where the WSD schema cannot be used. However, when there is a standard TCP/IP port connection, because obtainment of the WSD schema may fail due to a setting of the printer, it is determined whether option configuration information obtainment succeeded (step S605). This determination can be performed from the details of a response, for example. In a case where obtainment of the WSD schema failed, communication with the printer 300 is performed via the port monitor 219 to obtain the option configuration information. This is similar to AutoConfig by the OS. However, particularly in a case where there are many option configurations, there is a possibility that many queries from the OS 1054 are repeated, and the printer cannot correctly respond to each query, and as a consequence AutoConfig fails. In such a case, obtainment of the option configuration information fails. Meanwhile, if the printer is set so that it can use a WSD schema, obtainment of the WSD schema in one batch succeeds.

Accordingly, in the case where obtainment of the WSD schema in one batch succeeds (Yes in step S605), similarly to when there is a WSD port connection, necessary option configuration information is extracted from the obtained WSD schema and registered in the QueuePropertyBag 2083 (step S606).

Meanwhile, in a case where obtainment of the WSD schema in one batch fails due to a setting of the printer (No in step S605), step S607 is branched to. In such a case, there is a possibility that obtainment of the option configuration information failed in AutoConfig as described above. Accordingly, in such a case, communication is performed with the printer 3000 via the port monitor 219, and, after waiting a certain time interval (step S607) a query for necessary information, in other words the option configuration information, is made (step S608). The necessary information is prepared in advance, and the query is made in accordance with it. The communication path is the same as that for AutoConfig by the OS 1054, but a method of obtainment differs. In AutoConfig by the OS 1054, configuration is such that the option information is obtained all at once, but queries in the PreConfig by the printer extension 210 query the printer for information on each single item by leaving a certain time interval. This certain interval indicates an interval by which the printer 3000 can reliably respond to a request for option configuration information (for example, approximately 10 ms to 100 ms), and in this way it is possible to reduce data loss of information. In addition, instead of one item at a time, the printer extension 210 can also request in one query a number of items that the printer 3000 can process. When all of the information could be obtained (Yes in step S609), the obtained configuration information is registered in the QueuePropertyBag 2083 (step S610). Configuration may be taken such that, if there is no response for an item of the option setting information that was requested, to resend the request in step S609. In addition, configuration may be taken such that after requesting all items, if there is an omission in the obtainment, the request for the omitted item is resent.

Note that, in the case of a USB port in the port discrimination determination (step S601) (a case where a USB port is determined in step S601), nothing in particular is done in the PreConfig because it is considered that obtaining of the option configuration information by AutoConfig will succeed.

In this manner, by setting the time interval for requests to a value appropriate to allow a response to be expected, it becomes easier to obtain corresponding configuration information from one request. Furthermore, by confirming that necessary configuration information was all obtained, it is possible to reliably obtain the configuration information. In accordance with use of the foregoing procedure, by performing PreConfig again even if data loss of the option configuration information occurs in AutoConfig at the time of the standard TCP/IP port connection, a data loss of option configuration information is less likely to occur.

### Second Embodiment

In the method of the first embodiment, a data loss of option configuration information obtainment is suppressed by performing PreConfig after AutoConfig. However, in the first embodiment, because configuration is such that PreConfig is always performed with respect to all printers, PreConfig is performed even if obtainment of all option configuration information succeeds by AutoConfig. Because this is simply doing the same thing, there is an influence on performance at an installation time. If there are a plurality of drivers to install, performance degrades in accordance with the number of drivers.

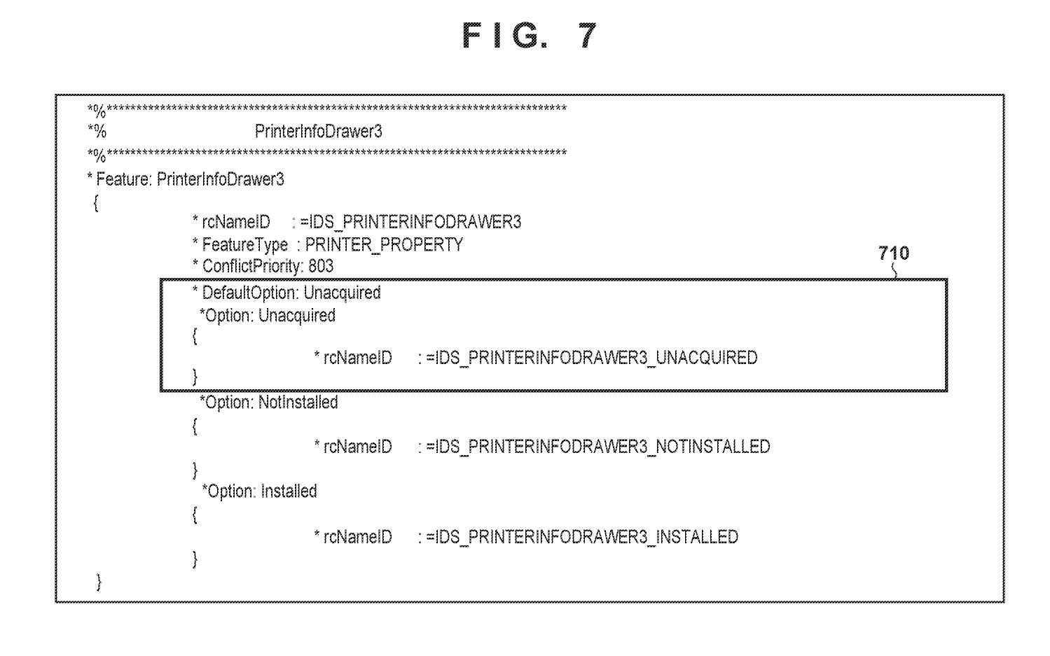

As a method to solve the foregoing problem, in the present embodiment, it is determined after AutoConfig whether all of the option configuration information to be obtained can be obtained, and PreConfig is performed only when obtainment failed even once. Because AutoConfig as explained in the first embodiment is controlled by the OS 1054, it is difficult to determine whether obtainment succeeded at a time of the obtainment processing. Accordingly, a value of “unobtained” is added to a value of a result of option configuration information obtained by AutoConfig. Normally the option configuration information defines values of “none” or “exists”. In AutoConfig, the foregoing values of “none” or “exists” are set based on information obtained from the printer 3000. At this time, option configuration information that could not be obtained by AutoConfig is set by converting it to a default value. In other words, usually it is converted to a value for “none”. Accordingly, a value corresponding to “unobtained” is defined in addition to “none” and “exists” for definitions of the option configuration information, and the default value is set to “unobtained”. FIG. 7 is an example of a definition of option configuration information obtained by AutoConfig of the print processing system according to embodiments. In the present example, “Unaquired” meaning “unobtained” is additionally defined (reference numeral 710) in addition to “Installed” meaning “exists” and “NotInstalled” meaning “none” for definitions of the configuration information of a cassette 3. In addition, a default value (a value defined by*Default Option) is set to Unacquired. In this way, “Unacquired” is set for option configuration information that could not be obtained by AutoConfig at a time of option configuration information obtainment.

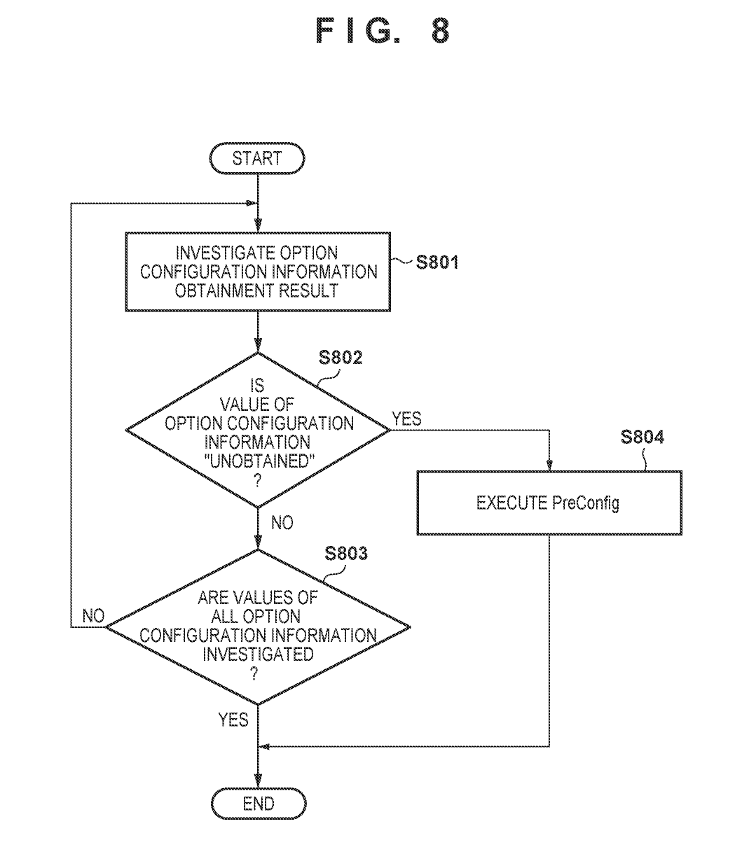

FIG. 8 is a flowchart for describing processing for determining whether or not to perform PreConfig at the time of an installation of the print processing system according to embodiments of the present invention. Unless particularly specified, processing of each step of the flowchart is performed by the printer extension 210 which is configured in the printer driver 1053. The printer extension 210 is stored in the auxiliary storage apparatus 105, loaded into the RAM 1022, and executed by the CPU 101.

As described by FIG. 5, this processing occurs when the installer 1052, having received a completion notification for the install process (step S502) from the OS 1054, requests the printer extension 210 for obtainment of configuration information. Firstly, a result of obtainment by AutoConfig is examined (step S801). If the option configuration information obtainment result is “unobtained” (Yes in step S802), PreConfig is performed (step S804). Because there is the same processing as FIG. 6 of the first embodiment for PreConfig, explanation thereof is omitted. Examination is made for all pieces of option configuration information as to whether the option configuration information is obtained (step S802 and step S803), and when all pieces of option configuration information has been obtained (Yes in step S803), PreConfig is not performed. Meanwhile, if there is even one piece of option configuration information that is not obtained, PreConfig is performed.

Because it is determined whether to perform PreConfig in accordance with an option configuration information obtainment status of AutoConfig by using the foregoing procedure, this leads to an improvement in performance when all the option configuration information can be correctly obtained by AutoConfig.

### Third Embodiment

In the second embodiment, whether to perform PreConfig is automatically determined based on an obtainment result by AutoConfig when the installer 1052 installs the printer driver 1053. However, in accordance with an office environment, there are cases where the printer driver 1053 is installed in a client computer 100 in advance, and after the client computer 100 is positioned it is connected with a printer 3000 and operated. In such a case, installation completes with the option configuration information unable to be obtained by the installer 1052. As a method to solve the foregoing problem, in the present embodiment, it is determined at a time of activation of a print setting screen whether all of the option configuration information to be obtained could be obtained, and PreConfig is performed only when obtainment failed even once.

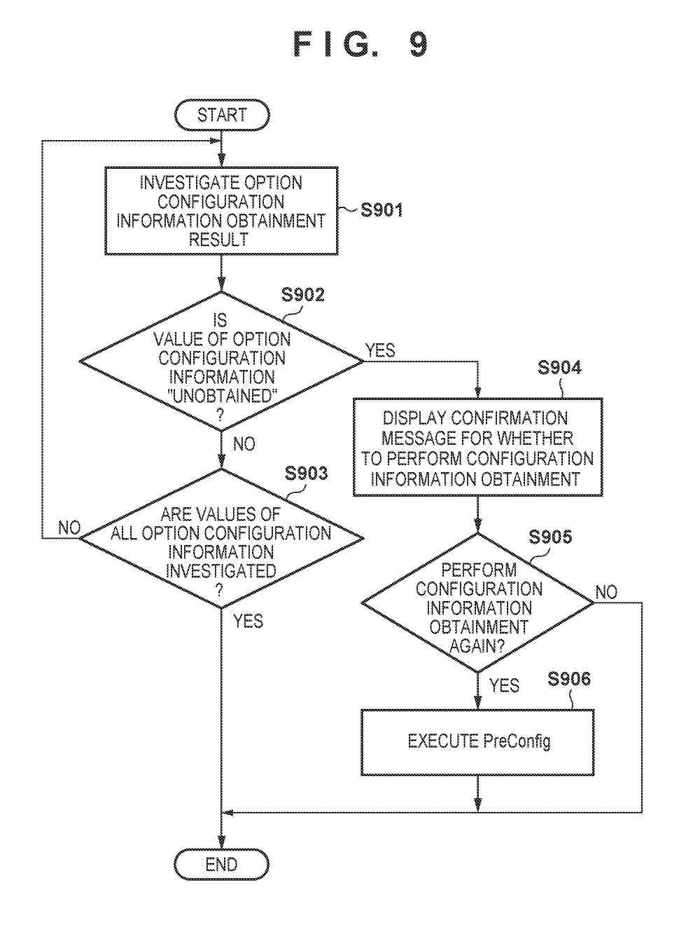

FIG. 9 is a flowchart for describing processing for determining whether or not to perform PreConfig at the time of an activation of a print setting screen in the print processing system according to embodiments of the present invention. Unless particularly specified, processing of each step of the flowchart is performed by the printer extension 210 which is configured in the printer driver 1053. The printer extension 210 is stored in the auxiliary storage apparatus 105, loaded into the RAM 1022, and executed by the CPU 101.

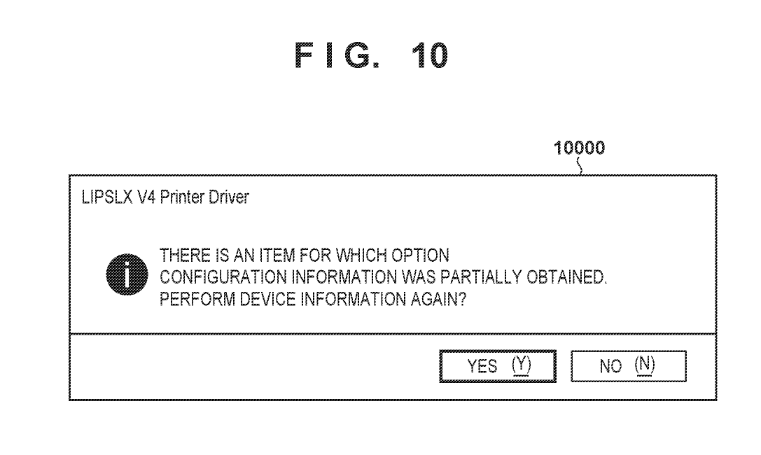

This processing occurs when the print setting screen is activated at a time of performing printing from the print application 1051. Step S901 through step S903 are the same as step S801 through step S803 explained in the second embodiment, and thus explanation thereof is omitted. When an option configuration information obtainment result is “unobtained” (Yes in step S902), a message indicating that there is an “unobtained” option configuration information obtainment result is displayed (step S904). A specific example of a message to display is illustrated in FIG. 10. However, there is no limitation to this. When the “yes” button of the main message screen 1000 is pressed by a user (Yes in step S905), PreConfig is performed (step S906). Because there is the same processing as FIG. 6 of the first embodiment for PreConfig, explanation thereof is omitted. When the “no” button of the main message screen 1000 is pressed (No in step S905), PreConfig is not performed.

Even in a case where option configuration information obtainment failed at the time of installation of a printer driver, by using the foregoing procedure, option configuration information obtainment based on a determination by a user becomes possible by automatically making a determination when a print screen is activated.

### Fourth Embodiment

In the third embodiment, configuration is such that a determination for whether it is necessary to perform PreConfig is made based on an obtainment result by AutoConfig at a time when a print setting screen is activated, and when necessary that necessity is notified to a user, and option configuration information obtainment can be performed based on a determination by the user. However, when the corresponding option configuration information is not defined by the printer 3000, obtainment will fail even if configuration information obtainment is performed by the printer driver 1053. Conventionally an option configuration for which information failed to be obtained is determined to operate as “none”, but in this case there is the problem that irrespective of the function being installed in the printer, the function cannot be used.

As a method of solving the foregoing problem, in the present embodiment, when there is a result corresponding to “unobtained” for option configuration information, operation corresponding to “exists” is performed.

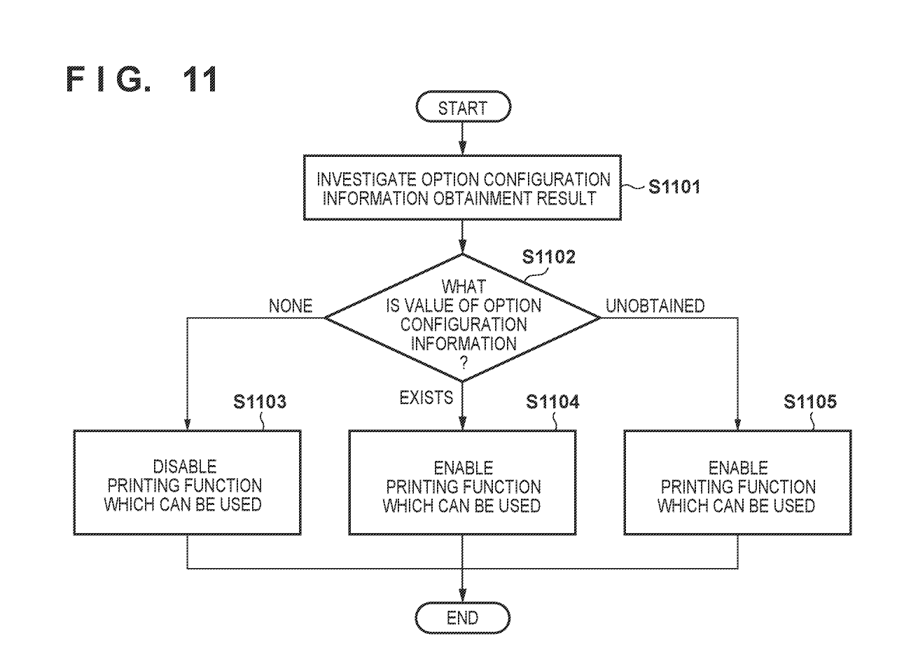

FIG. 11 is a flowchart for describing processing for determining whether to enable/disable a setting item at a time of activation of a print setting screen in the print processing system according to embodiments of the present invention. Unless particularly specified, processing of each step of the flowchart is performed by the printer extension 210 which is configured in the printer driver 1053. The printer extension 210 is stored in the auxiliary storage apparatus 105, loaded into the RAM 1022, and executed by the CPU 101.

This processing occurs when the print setting screen is activated at a time of performing printing from the print application 1051. Firstly, a result for option configuration information related to a corresponding print setting item is examined (step S1101). If the result of the option configuration information is a value that corresponds to “none” (None in step S1102), the function that could be used is disabled (step S1103). If the result of the option configuration information is a value that corresponds to “exists” (Exists in step S1102), the function that could be used is enabled (step S1104). If the result of the option configuration information is a value that corresponds to “unobtained” (Unobtained in step S1102), the function that could be used is enabled (step S1105).

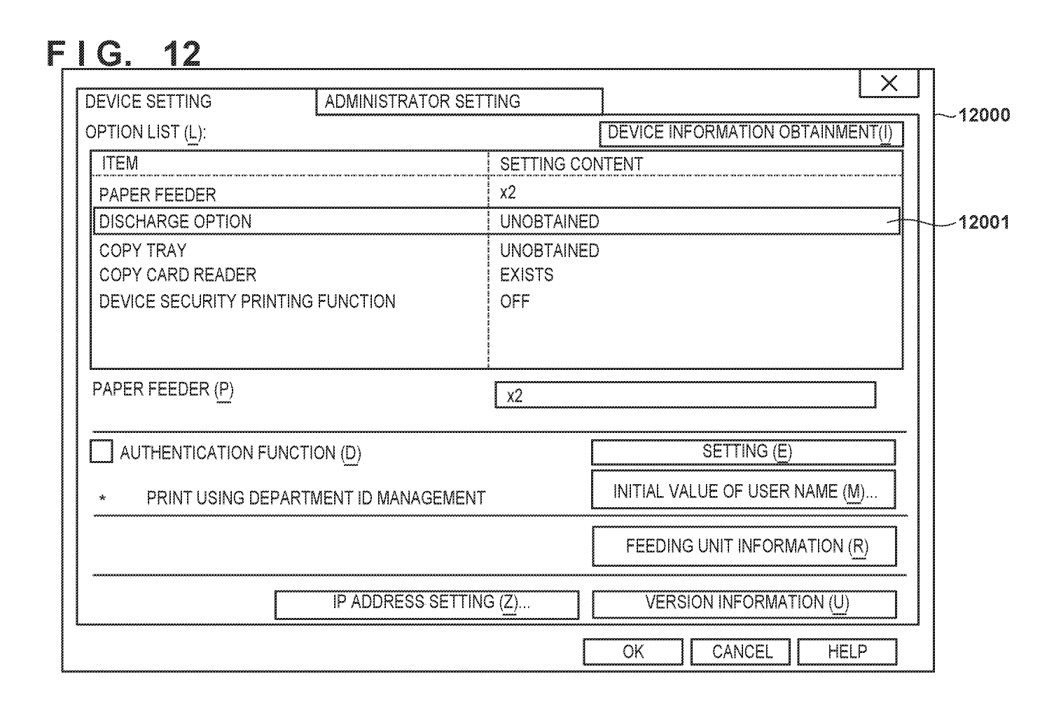

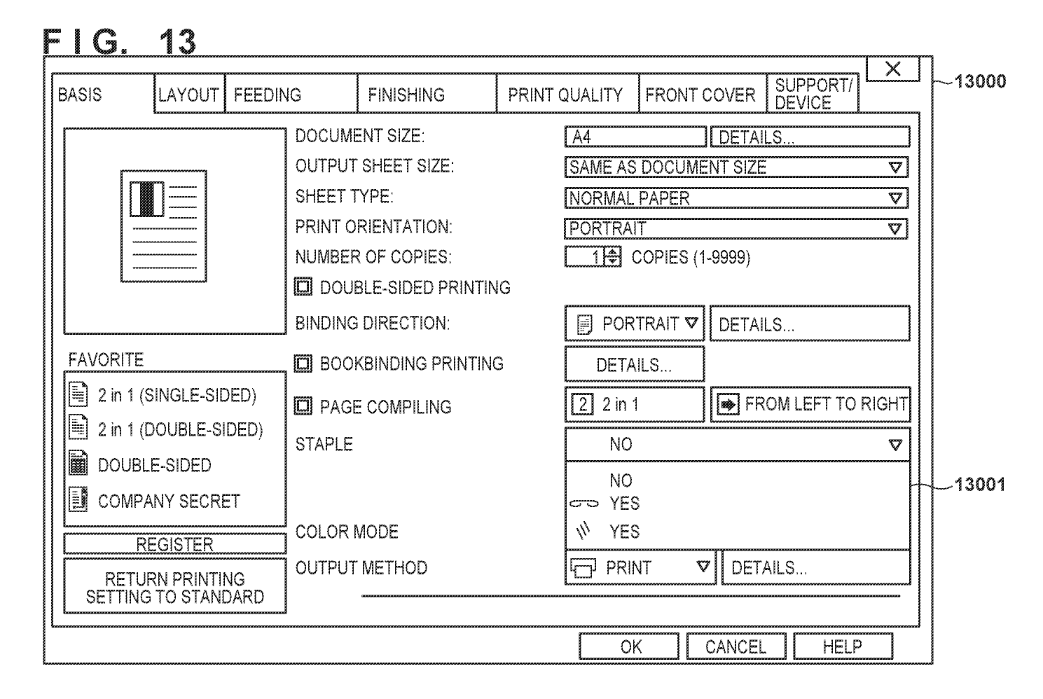

For example, if, as a result of performing an option configuration information obtainment, there was a failure for option configuration information for “discharge option” 12001 and it became “unobtained” as in FIG. 12, in the conventional case a selection item for “staple” 13001 in the print setting screen of FIG. 13 would only have the choice of “no”. However, in the present embodiment, for “discharge option” 12001, because a case of unobtained operates corresponding to “exists”, the “staple” 13001 will have the options “yes” and “yes (staple-less binding)” in addition to “no”, and these become selectable states.

By using the foregoing procedure, even if there is a failure for option configuration information, a case of determining a state where the information could not be obtained operates as if the corresponding option configuration “exists”, and the function can be used.

### Other Embodiments

Examples regarding obtainment of configuration information from a printer such as at a time of installation of a printer driver which is an example of a device driver are explained above. However, it is also possible to apply the present invention to a peripheral apparatus that is not a printer if the peripheral apparatus is a device that has an option configuration (such as a scanner, a camera, and a 3D printer). In other words, similarly to the embodiments described above, it is possible to obtain configuration information from a device, and, based on the configuration information, use a device driver to make use of the option configuration, or cause a user to perform a setting.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-016118, filed Jan. 31, 2017 which is hereby incorporated by reference herein in its entirety.

What is claimed is:

1. An information processing apparatus operable to execute an operating system, wherein the operating system is configured to, at a time of an installation of a device driver, perform obtainment processing for executing, by using a first time interval, a plurality of requests for obtaining configuration information from a peripheral apparatus corresponding to the device driver, the information processing apparatus comprising:
a memory storing instructions; and
a processor which is capable of executing the instructions causing the information processing apparatus to:
at a time different to the obtainment processing by the operating system and after the installation of the device driver, execute, by using a second time interval which is a time interval longer than the first time interval, a plurality of requests for obtaining the configuration information from the peripheral apparatus by using a module having a function for obtaining the configuration information, and
wherein information obtained by using the module, which is not the operating system, is saved as the configuration information of the peripheral apparatus.

2. The information processing apparatus according to claim 1, wherein the instructions further cause the information processing apparatus to determine a type of a port set in the device driver, and
wherein, if the type of the port is determined to be a TCP/IP port, the plurality of requests using the module are executed by using the second time interval.

3. The information processing apparatus according to claim 2, wherein the instructions further cause the information processing apparatus to, if the type of the port is determined to be a TCP/IP port, request the peripheral apparatus for a WSD (Web Services for Devices) schema that includes the configuration information before executing the plurality of requests using the module, and
wherein, if obtainment of the WSD schema fails, the plurality of requests using the module are executed by using the second time interval.

4. The information processing apparatus according to claim 3,
wherein the instructions further cause the information processing apparatus to obtain the configuration information included in the WSD schema when obtainment of the WSD schema succeeds.

5. The information processing apparatus according to claim 1,
wherein the instructions further cause the information processing apparatus to record an obtainment result for the configuration information, and
record, in accordance with the obtainment result, a first value indicating that a configuration corresponding to the configuration information is not present in the peripheral apparatus, a second value indicating that the configuration is present, and a third value indicating that the configuration information is unobtained.

6. The information processing apparatus according to claim 5,
wherein the instructions further cause the information processing apparatus to present a setting screen for performing a setting of the peripheral apparatus in accordance with the recorded configuration information, and
if a recorded value is the third value, enable a function provided by the corresponding configuration, and configure the setting screen so that the function can be selected.

7. The information processing apparatus according to claim 5,
wherein the instructions further cause the information processing apparatus to, if a recorded value is the third value, obtain the configuration information by executing the plurality of requests.

8. The information processing apparatus according to claim 1,
wherein the plurality of requests, which is for obtaining the configuration information from the peripheral apparatus and is made using the second time interval and uses the module having the function for obtaining the configuration information, is started in accordance with a request from an installer of the device driver responding to an installation completion notification of the device driver from the operating system.

9. The information processing apparatus according to claim 1,
wherein the instructions further cause the information processing apparatus to, by using the second time interval, execute, in accordance with completion of the obtainment processing by the operating system, the plurality of requests for obtaining the configuration information from the peripheral apparatus using the module having the function for obtaining the configuration information.

10. The information processing apparatus according to claim 1,
wherein the module having the function for obtaining the configuration information is realized by a related application of the device driver installed on the information processing apparatus.

11. The information processing apparatus according to claim 1,
wherein the peripheral apparatus is a printer, and
the configuration information is option configuration information indicating a configuration of an option unit of the printer.

12. A non-transitory computer-readable storage medium on which is stored a computer program for making a computer execute a method for an information processing apparatus operable to execute an operating system configured to, at a time of an installation of a device driver to the information processing apparatus, perform obtainment processing for executing, by using a first time interval, a plurality of requests for obtaining configuration information from a peripheral apparatus corresponding to the device driver, the method comprising:
at a time different to the obtainment processing by the operating system and after the installation of the device driver, execute, by using a second time interval which is a time interval longer than the first time interval, a plurality of requests for obtaining the configuration information from the peripheral apparatus by using a module having a function for obtaining the configuration information, and
wherein information obtained by using the module, which is not the operating system, is saved as the configuration information of the peripheral apparatus.

13. The medium according to claim 12, wherein the method further comprises:
determining whether a type of a port on which the device driver is set, and
wherein the method executes the plurality of requests by using at least the second time interval if the type of the port is determined to be a TCP/IP port.

14. The medium according to claim 12, wherein the method further comprises:
recording an obtainment result of the configuration information,
wherein, in the recording, in accordance with the obtainment result, a first value indicating that a configuration corresponding to the configuration information is not present in the peripheral apparatus, a second value indicating that the configuration is present, and a third value indicating that the configuration information is unobtained are recorded.

15. The medium according to claim 14, wherein the method further comprises:
configuring so that, when presenting a setting screen for performing a setting of the peripheral apparatus, if the value recorded in the recording is the third value, a function provided by a corresponding configuration is enabled, and selection of the function is enabled.

16. The medium according to claim 12, wherein
the plurality of requests for obtaining the configuration information from the peripheral apparatus made using the second time interval using the module having the function for obtaining the configuration information is started in response to an installation completion notification of the device driver from the operating system.

17. The medium according to claim 12, wherein
in the obtaining, the plurality of requests for obtaining the configuration information from the peripheral apparatus by using the second time interval are executed, by using the module having the function for obtaining the configuration information, in response to completion of the obtainment processing by the operating system.

18. A method of an information processing apparatus operable to execute an operating system, wherein the operating system is configured to, at a time of an installation of a device driver, performs obtainment processing for executing a plurality of requests by a first time interval in order to obtain configuration information from a peripheral apparatus corresponding to the device driver, the method comprising:
at a time different to the obtainment processing by the operating system and after the installation of the device driver, executing a plurality of requests by using a second time interval which is a time interval longer than the first time interval in order to obtain the configuration information from the peripheral apparatus by using a module having a function for obtaining the configuration information, and
wherein information obtained by using the module, which is not the operating system, is saved as the configuration information of the peripheral apparatus.
